(19) United States
(12) Patent Application Publication
(10) Pub. No.: US 2008/0301229 A1
(43) Pub. Date: Dec. 4, 2008

(54) CLIENT DEVICE, COMMUNICATION METHOD AND COMPUTER READABLE MEDIUM

(75) Inventor: Tatsuya Jimmei, Kawasaki-Shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/054,599

(22) Filed: Mar. 25, 2008

(30) Foreign Application Priority Data
May 28, 2007 (JP) 2007-140631

(51) Int. Cl. G06F 15/16

(52) U.S. Cl. 709/204

(57) ABSTRACT

There is provided with a client device connected to a network, including: a first message sender configured to send a first request message for requesting assignment of an address to communicate in the network to one or more servers on the network; a waiting unit configured to wait for an address candidate notification message including a candidate of the address to be assigned to arrive from each server for a certain period after the first request message is sent; a message reception unit configured to receive the address candidate notification message from each server within the period after the first request message is sent; and a duplication inspection unit configured to inspect whether or not the candidate of the address included in the address candidate notification message received from each sever is already assigned to an other client device, before the period elapses after the first request message is sent.

### CROSS REFERENCE TO RELATED APPLICATIONS

This application is based upon and claims the benefit of priority from the prior Japanese Patent Applications No. 2007-140631, filed on May 28, 2007; the entire contents of which are incorporated herein by reference.

### BACKGROUND OF THE INVENTION

1. Field of the Invention

The present invention relates to a client device which is assigned an address from a server, a communication method of communicating with the server and a computer readable medium storing a program for communicating with the server.

2. Related Art

One of the features of IP (Internet Protocol) v6 which attracts attention as a next-generation Internet technology is an automatic setting function which enables an end host to access a network without any complicated setting operation. For the automatic setting, an IP address setting for a host allows for the use of a Stateless Address Configuration defined in RFC2462 or the use of Dynamic Host Configuration Protocol (DHCPv6) defined in RFC3315 or the like.

DHCPv6 is a server/client type protocol and sets addresses in the form of assigning some of addresses managed by a server to hosts (client device or simply client). This address setting is required to assign unduplicated addresses to respective clients at an early stage.

Incidentally, as relevant documents, there are “IETF RFC3315 Dynamic Host Configuration Protocol for IPv6 (DHCPv6)” and “IETF RFC2462 IPv6 Stateless Address Autoconfiguration”.

### SUMMARY OF THE INVENTION

According to an aspect of the present invention, there is provided with a client device which is connected to a network, comprising:

a first message sender configured to send a first request message for requesting assignment of an address to communicate in the network to one or more servers on the network managing the addresses to communicate in the network;

a waiting unit configured to wait for an address candidate notification message including a candidate of the address to be assigned to arrive from each server for a certain period after the first request message is sent;

a message reception unit configured to receive the address candidate notification message arriving from each server within the certain period after the first request message is sent; and

a duplication inspection unit configured to inspect whether or not the candidate of the address included in the address candidate notification message received from each sever is already assigned to an other client device on the network, before the certain period elapses after the first request message is sent.

According to an aspect of the present invention, there is provided with a communication method performed in a client device connected to a network, comprising:

sending a first request message for requesting assignment of an address to communicate in the network to one or more servers on the network managing the addresses to communicate in the network;

waiting for an address candidate notification message including a candidate of the address to be assigned to arrive from each server for a certain period after the first request message is sent;

receiving the address candidate notification message arriving from each server within the certain period after the first request message is sent; and

inspecting whether or not the candidate of the address included in the address candidate notification message received from each sever is already assigned to an other client device on the network, before the certain period elapses after the first request message is sent.

According to an aspect of the present invention, there is provided with a computer readable medium storing a computer program for causing a computer connected to a network, to execute instructions to perform the steps of:

sending a first request message for requesting assignment of an address to communicate in the network to one or more servers on the network managing the addresses to communicate in the network;

waiting for an address candidate notification message including a candidate of the address to be assigned to arrive from each server for a certain period after the first request message is sent;

receiving the address candidate notification message arriving from each server within the certain period after the first request message is sent; and

inspecting whether or not the candidate of the address included in the address candidate notification message received from each sever is already assigned to an other client device on the network, before the certain period elapses after the first request message is sent.

### BRIEF DESCRIPTION OF THE DRAWINGS

FIG. 1 shows the basic configuration of a network according to the embodiment of the present invention;

FIG. 2 is a flowchart illustrating the operation of a host according to the;

FIG. 3 shows an example of messages exchanged between the host and server in the procedure in FIG. 2;

FIG. 4 is a flowchart showing a typical procedure for an address setting according to a prior art; and

FIG. 5 shows an example of messages exchanged between the host and server in the procedure in FIG. 4.

### DETAILED DESCRIPTION OF THE INVENTION

First, an address setting based on DHCPv6 known to the inventor before conceiving the present invention will be explained.

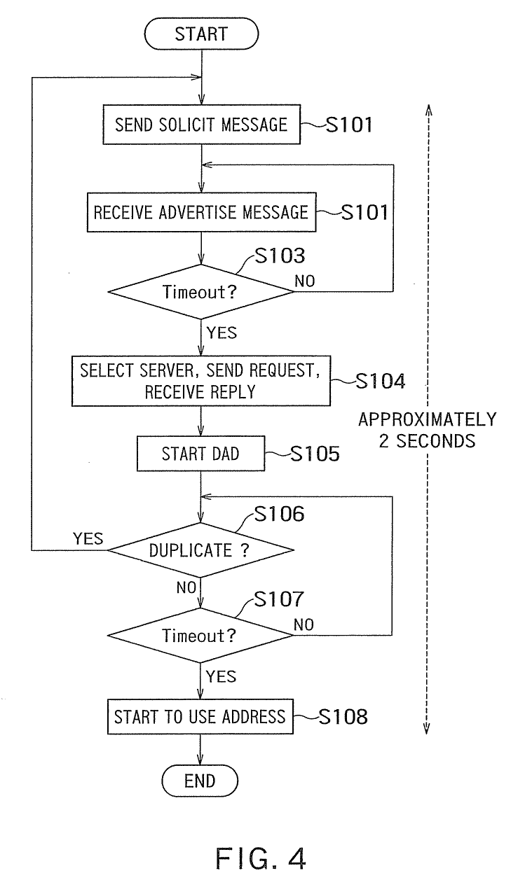

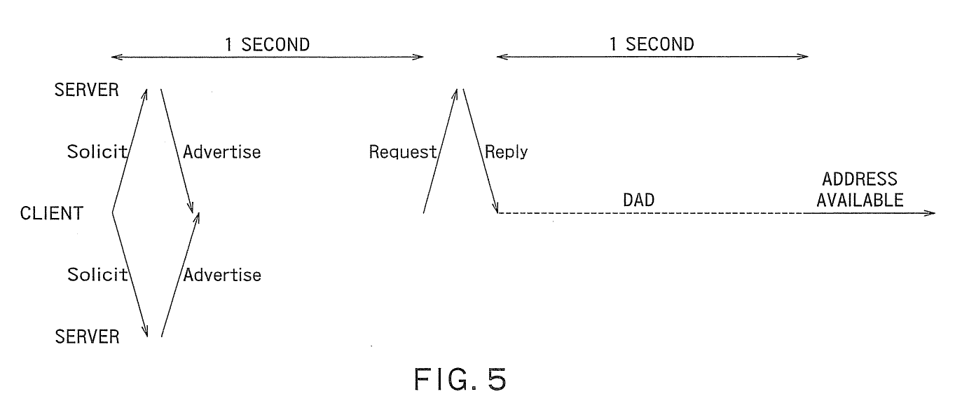

As described above, DHCPv6 is a server/client type protocol and performs address settings by assigning some of addresses managed by a server to hosts. The flowchart in FIG. 4 shows a typical procedure in such a case. Furthermore, FIG. 5 shows how messages are exchanged between the client and server according to this procedure in chronological order.

First, the client transmits a Solicit message for a server search as a multicast packet in step S101.

In response to this, the server writes an address scheduled to assign to the transmission source client in an IA Address option in step S102 and sends it as an Advertise message in reply. When there are a plurality of servers which have received the multicast Solicit message, the respective servers send an Advertise message in reply. FIG. 5 shows an example where two servers exist.

In step S103, the client waits for the Advertise message from the server for one second (or for a certain period) and then in step S104, selects one of the servers which have sent the Advertise messages obtained in the meantime. The example in FIG. 5 shows a case where of the two servers, the server located above in the figure is selected. The waiting time here actually includes a random delay within 0.1 seconds in addition to one second to avoid synchronization in operations with other clients. However, for simplicity of explanation, suppose the waiting time is simply one second.

Criteria for selection of a server by a client are not defined in the protocol specification except in special cases and depend on the implementation of the client. In step S104, the client further sends a Request message to the selected server. Upon receiving this, the server secures one of assignable addresses held for the client and sends a Reply message including the address as an IA Address option to the client in reply.

Here, the address actually assigned by the Reply message normally matches the address notified by the Advertise message. Furthermore, the Advertise and Reply messages may include two or more addresses, but for simplicity, the following explanations will assume a most common mode. That is, suppose the number of addresses included in these messages is one.

Upon receiving the Reply message in response to the Request message, the client then starts duplicate address detection (DAD) defined as part of RFC2462 in step S105. In the duplicate address detection (DAD), the client sends a search packet to determine whether or not there exists any node using the assigned address within a link and waits for a response for a defined time (normally one second). When addresses are correctly managed, there exists normally no node using the same address and the client never receives any response. When no response is received after a lapse of a defined time (NO in S106, YES in S107), the client can use the assigned address in step S108.

On the other hand, when there already exists a node using this address, the node responds to the search packet of the client. This causes the client to realize that the address is duplicate (YES in S106) and send a Decline message to the server informing that the assigned address cannot be used.

Therefore, a time of at least two seconds is required after the address setting by DHCPv6 is started until the address can be actually used. This becomes a delay which is not negligible for such a mobile device or the like that moves between different links with relatively high frequency.

Furthermore, when a plurality of servers which can assign addresses transmit an Advertise message, even in a situation in which an address assigned by a server is already used by another node, the client cannot know it until duplicate address detection is performed after the Request and Reply messages. That is, despite the situation in which the other server sending Advertise is actually preferable, there is no secure means for selecting the server at a stage at which the Advertise message is received. This results in a delay deriving from a procedure whereby duplicate addresses are detected through duplicate address detection and other servers are then queried.

Hereinafter, an embodiment of the present invention will be explained in detail with reference to drawings.

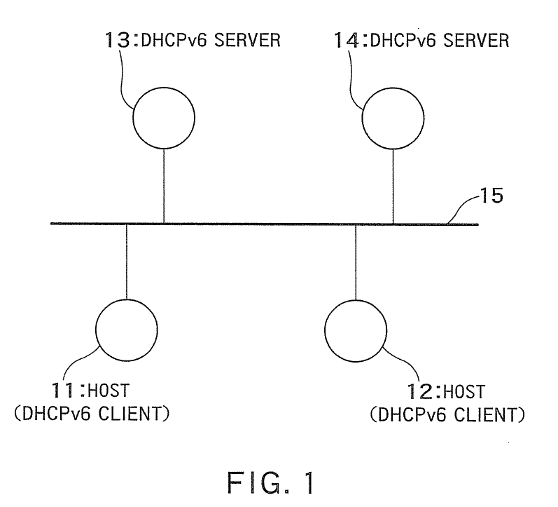

FIG. 1 shows the overall configuration of a network according to an embodiment of the present invention.

A host (client device) 11, a host (client device) 12, a server 13 and a server 14 are connected together via a network 15. The host 11 is a DHCPv6 client according to this embodiment. The server 13 and server 14 are DHCPv6 servers which assign an address to the host 11. The host 11 communicates with a communication device (may be another host or a server which provides a service such as a Web server) on the network using the assigned address. Furthermore, suppose the host 12 exists on the same subnet as that of the host 11 and has already completed an address setting and is operating. For simplicity, FIG. 1 assumes that these hosts and servers exist on the same subnet, but the scheme of the present invention is also applicable to a case where the server is in a remote place and is exchanging with the host via a relay device called “relay agent.”

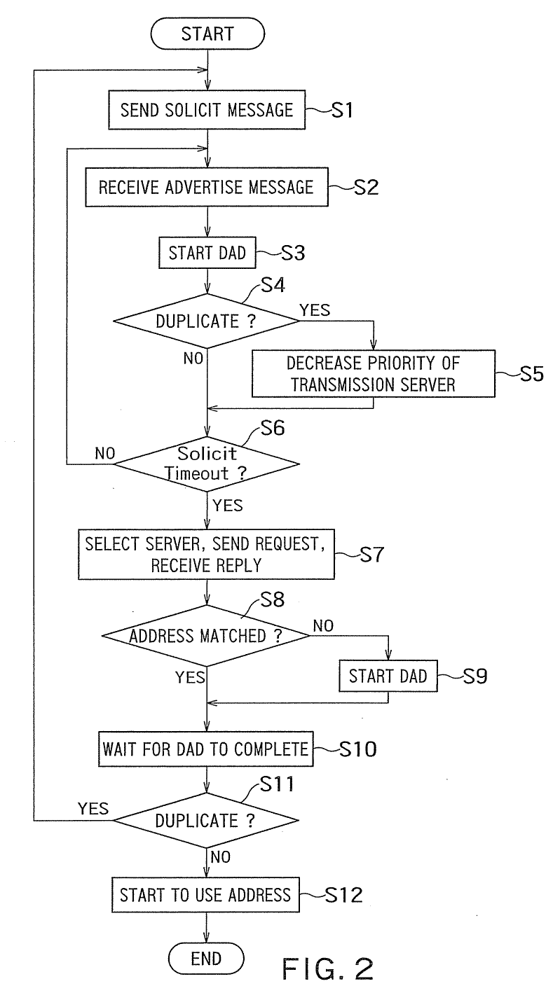

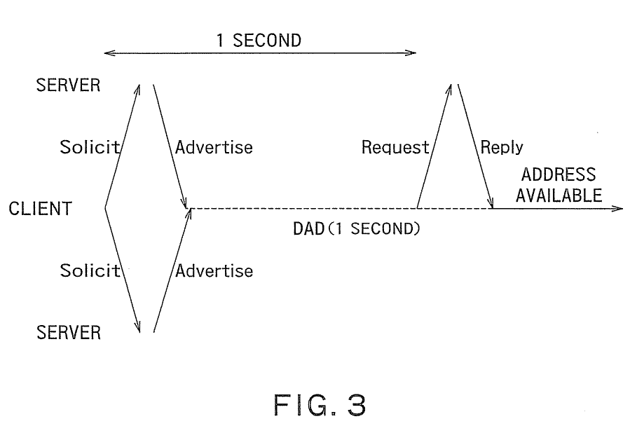

FIG. 2 is a flowchart illustrating the operation of the host 11 according to the present invention. Furthermore, FIG. 3 shows how messages are exchanged between the client and the server according to the procedure in FIG. 2 in chronological order. Processing in respective steps can also be realized by causing a general-purpose computer to execute a program in which operation code is written which instructs the execution of the respective steps shown in the flowchart in FIG. 2. Furthermore, this program can also be executed by storing it in a computer readable storage medium such as a hard disk, CD-ROM or memory card and reading the program from this storage medium.

First, in a normal case, that is, a case where an address assigned to the host 11 is not a duplicate one will be explained.

The host 11 sends a Solicit message according to the protocol procedure of DHCPv6 in step S1 and waits for an Advertise message from the server. In the network shown in FIG. 1, the server 13 and server 14 send an Advertise message in reply. The Solicit message corresponds, for example, to a first request message. Furthermore, the processing in step S1 corresponds to processing by a first message sender and the host 11 is provided with the first message sender.

The host 11 receives the first Advertise message in step S2, and starts duplicate address detection (DAD) defined as part of RFC2462 on an IPv6 address included in the IA Address option in the Advertise message in step S3. That is, the host 11 is provided with a duplication inspection unit for inspecting whether the IPv6 address is a duplicate of addresses of other hosts without waiting for a lapse of waiting time for a reply to the Solicit message. Since a case where no duplicate exists will be considered here, a testing in step S4 is always false (NO) and the host 11 moves to step S6. The Advertise message corresponds, for example, to an address candidate notification message. Furthermore, the processing in step S2 corresponds, for example, to processing by a message reception unit and the host 11 is provided with the message reception unit.

In step S6, whether or not a waiting time (1 second) for the reply to the Solicit message has elapsed is tested and the operation from step S2 to step S6 is repeated while the testing result is false (NO). In the network environment shown in FIG. 1, the procedure from step S2 to step S6 is repeated twice because the Advertise message is received from the two servers 13 and 14. The processing in step S6 corresponds, for example, to processing by a waiting unit and the host 11 is provided with the waiting unit.

When the waiting time (1 second) for the reply to the Solicit message has elapsed, the testing result in step s6 becomes true (YES) and the host 11 moves to step S7. In step S7, the host 11 selects any one of the server 13 and server 14, sends a Request message and receives a Reply message from the server. In this case, there is no difference which server is selected in the implementation of the present invention. The Reply message includes the address assigned by the server.

Next in step S8, the host 11 confirms whether the address assigned by the Reply message matches the address notified by the Advertise message. In the case of a match (YES in S8), the host 11 moves to step S10 and waits for duplicate address detection to be completed. Since the case where there is no duplicate address is considered here, the inspection procedure ends normally (the result in step S11 becomes false (NO)), the host 11 can use the address assigned from the server in step S12.

In the above described processing, the time after the duplicate address detection (DAD) starts in step S3 until it is completed in step S10 is one second (this time is predefined by a protocol). On the other hand, the time required from step S1 to step S3 is negligibly small because only messages with little delay are exchanged. Therefore, the host 11 according to the procedure of the present invention can complete the whole operation involving the address setting including the duplicate address detection in approximately one second. That is, the duplicate address detection can be shortened by one second compared with the normal procedure.

In step S8, when the address included in the Reply message is different from the address notified by the Advertise message (NO in S8), the host 11 moves to step S9 and starts new duplicate address detection (DAD) on the assigned address. In this case, the mode is equivalent to the conventional one. However, the addresses included in the Reply message and Advertise message generally match in practice and a mismatch is an exceptional case. Furthermore, the time required in the procedure of the present invention is equivalent to that in the conventional mode and no additional delay is produced in this case, either.

Next, a case where the address assigned to the host 11 is already used by the host 12 and duplicate will be explained. Suppose the duplicate address is A and the server 13 assigns this address. Furthermore, suppose the server 14 assigns an address B which is different from this.

In the same way as the above described case, the host 11 sends a Solicit message according to the protocol procedure of DHCPv6 in step S1 and waits for an Advertise message from the server. Upon receiving the Advertise message from the server 13 in step S2, the host 11 starts duplicate address detection (DAD) on the notified address A in step S3. Since the address A is already used by the host 12, the host 12 responds to a search packet of the duplicate address detection sent from the host 11 and upon receiving this response, the host 11 detects the duplication (YES in S4). The host 11 then reduces the priority of the server 13 which has notified this address (S5).

Next, the host 11 returns to step S2, receives an Advertise message from the server 14 and starts duplicate address detection on the address B advertised by the Advertise message in step S3. On the assumption that there is no duplication on the address B, the decision result in step S4 becomes false (NO), and the host 11 waits until the waiting time (one second) for a reply to a Solicit message elapses in step S6.

Next, the host 11 selects any one of the server 13 and server 14 in step S7 and sends a Request message. Here, since the priority for the server 13 has been reduced in step S6, the host 11 selects the server 14 with higher priority and sends a Request message. The processing of selecting the server with high priority corresponds to processing by a selecting unit and the processing of sending a Request message to the selected server corresponds to processing by a second message sender and the host 11 is provided with the selecting unit and the second message sender.

The procedure hereinafter is the same as the case where there is no address duplication.

Furthermore, in the same way as when there is no address duplication, the time after transmission of the Solicit message in step S1 until the address can be used in step S12 is also shortened to approximately one second.

Here, the case where the host 11 receives an Advertise message from the server 13 first has been explained, but the essential procedure and necessary time are equivalent also when a message is received from the server 14 first.

As described above, according to the embodiment of the present invention, when the IP address is set using DHCPv6, the time conventionally required for duplicate address detection (DAD) can be virtually omitted and the host can use the IP address assigned from the server speedily.

Furthermore, according to the embodiment of the present invention, a plurality of DHCPv6 servers assign different addresses and when some of these addresses are actually duplicate with addresses of other nodes, it is possible to detect the duplication at an early stage and preferentially select a server which assigns unduplicated addresses. As a result, this effect also has an effect of shortening the time of IP address setting by hosts as well.

What is claimed is:

1. A client device which is connected to a network, comprising:
a first message sender configured to send a first request message for requesting assignment of an address to communicate in the network to one or more servers on the network managing the addresses to communicate in the network;
a waiting unit configured to wait for an address candidate notification message including a candidate of the address to be assigned to arrive from each server for a certain period after the first request message is sent;
a message reception unit configured to receive the address candidate notification message arriving from each server within the certain period after the first request message is sent; and
a duplication inspection unit configured to inspect whether or not the candidate of the address included in the address candidate notification message received from each sever is already assigned to an other client device on the network, before the certain period elapses after the first request message is sent.

2. The device according to claim 1, wherein the first request message is a Solicit message defined in RFC3315 and the address candidate notification message is an Advertise message defined in the RFC3315.

3. The device according to claim 1, further comprising
a selecting unit configured to select the server from which the address candidate notification message including the candidate of the address not yet assigned to the other client device is received;
a second message sender configured to send, after the certain period is elapsed, a second request message for requesting assignment of the candidate of the address included in the address candidate notification message to selected server.

4. The device according to claim 3, wherein
the first request message is a Solicit message defined in RFC3315,
the address candidate notification message is an Advertise message defined in the RFC3315 and
the second request message is a Request message defined in the RFC3315.

5. The device according to claim 1, wherein the duplication inspection unit perform an inspection based on duplicate address detection (DAD) defined in RFC2462.

6. A communication method performed in a client device connected to a network, comprising:
sending a first request message for requesting assignment of an address to communicate in the network to one or more servers on the network managing the addresses to communicate in the network;
waiting for an address candidate notification message including a candidate of the address to be assigned to arrive from each server for a certain period after the first request message is sent;
receiving the address candidate notification message arriving from each server within the certain period after the first request message is sent; and
inspecting whether or not the candidate of the address included in the address candidate notification message received from each sever is already assigned to an other client device on the network, before the certain period elapses after the first request message is sent.

7. The method according to claim 6, wherein the first request message is a Solicit message defined in RFC3315 and the address candidate notification message is an Advertise message defined in the RFC3315.

8. The method according to claim 6, further comprising
selecting the server from which the address candidate notification message including the candidate of the address not yet assigned to the other client device is received;
sending, after the certain period is elapsed, a second request message for requesting assignment of the candidate of the address included in the address candidate notification message to selected server.

9. The method according to claim 8, wherein
the first request message is a Solicit message defined in RFC3315,
the address candidate notification message is an Advertise message defined in the RFC3315 and
the second request message is a Request message defined in the RFC3315.

10. The method according to claim 6, wherein the duplication inspection unit perform an inspection based on duplicate address detection (DAD) defined in RFC2462.

11. A computer readable medium storing a computer program for causing a computer connected to a network, to execute instructions to perform the steps of:
sending a first request message for requesting assignment of an address to communicate in the network to one or more servers on the network managing the addresses to communicate in the network;
waiting for an address candidate notification message including a candidate of the address to be assigned to arrive from each server for a certain period after the first request message is sent;
receiving the address candidate notification message arriving from each server within the certain period after the first request message is sent; and
inspecting whether or not the candidate of the address included in the address candidate notification message received from each sever is already assigned to an other client device on the network, before the certain period elapses after the first request message is sent.

12. The medium according to claim 11, wherein the first request message is a Solicit message defined in RFC3315 and the address candidate notification message is an Advertise message defined in the RFC3315.

13. The medium according to claim 11, storing the computer program for causing the computer to further execute instructions to perform the steps of:
selecting the server from which the address candidate notification message including the candidate of the address not yet assigned to the other client device is received; and
sending, after the certain period is elapsed, a second request message for requesting assignment of the candidate of the address included in the address candidate notification message to selected server.

14. The medium according to claim 13, wherein
the first request message is a Solicit message defined in RFC3315,
the address candidate notification message is an Advertise message defined in the RFC3315 and
the second request message is a Request message defined in the RFC3315.

15. The medium according to claim 11, wherein the duplication inspection unit perform an inspection based on duplicate address detection (DAD) defined in RFC2462.
